(19) United States
(12) Patent Application Publication
(10) Pub. No.: US 2017/0353014 A1
(43) Pub. Date: Dec. 7, 2017

(54) RACKMOUNT CASE FOR THE ACCOMMODATION OF OPTICAL EQUIPMENT

(71) Applicant: BELDEN CANADA INC., SAINT-LAURENT (CA)

(72) Inventors: MARC FONTAINE, LES CEDRES (CA); VINCENT PILON, LACHINE (CA)

(21) Appl. No.: 15/615,922

(22) Filed: Jun. 7, 2017

Related U.S. Application Data
(60) Provisional application No. 62/346,762, filed on Jun. 7, 2016.

(51) Int. Cl. H02B 1/06; G02B 6/44; H02B 1/01

(52) U.S. Cl. CPC H02B 1/066; H02B 1/013; G02B 6/4453; G02B 6/4452

(57) ABSTRACT

There is disclosed a rackmount case for the accommodation of optical equipment. The case comprises a metal housing comprising an open end, and a door comprising dimensions substantially the same as the open end for selectively opening and closing the open end, the door comprising a structural member made from metal and hinged to the housing along a long edge of the open end, and an aesthetic member made from plastic. The aesthetic member at least partially covers the structural member and comprises a one-way attachment comprising a plurality of protrusions and the structural member comprises a plurality of recesses for receiving the protrusions, each of the protrusions comprising a deformable head for engaging with a shoulder of a respective one of the recesses to hold the aesthetic member relative to the structural member.

### CROSS REFERENCE TO RELATED APPLICATIONS

This application claims benefit under 35 U.S.C. §119(e) of U.S. provisional application Ser. No. 62/346,762 filed on Jun. 7, 2016 which is incorporated herein in its entirety by reference.

### FIELD OF THE INVENTION

The present invention relates to a rackmount case for the accommodation of optical equipment.

### BACKGROUND OF THE INVENTION

An exemplary rackmount case of the prior art comprises a door, which includes a metal member and a plastic member. The plastic member is fixed to the metal member by means of a plurality of screws. This door of the prior art rackmount case requires an elaborate assembly and a plurality of parts.

It is an object of the invention to facilitate the assembly of a rackmount case and a door of a rackmount case. It is a further object of the invention to provide a cost-efficient rackmount case and door.

### SUMMARY OF THE INVENTION

There is provided a rackmount case for the accommodation of optical equipment. The case comprises a metal housing comprising an open end, and a door comprising dimensions substantially the same as the open end for selectively opening and closing the open end, the door including a structural member made from metal and hinged to the housing along an edge of the open end, and an aesthetic member made from plastic, the aesthetic member at least partially covering the structural member. The aesthetic member comprises a one-way attachment system comprising a plurality of post like protrusions and the structural member comprises a plurality of recesses for receiving the protrusions, each of the protrusions comprising a head deformed by heat for engaging with a shoulder of a respective one of the recesses to hold the aesthetic member relative to the structural member.

### BRIEF DESCRIPTION OF THE DRAWINGS

FIG. 1 is an isometric view of a rackmount case in accordance with an illustrative embodiment of the present invention;

FIG. 2 is an isometric view of the rackmount case, wherein a door of the rackmount case is open and in accordance with an illustrative embodiment of the present invention;

FIG. 3 is an isometric view of the door of the rackmount case and in accordance with an illustrative embodiment of the present invention;

FIG. 4 is an isometric view of an aesthetic member of the door and in accordance with an illustrative embodiment of the present invention;

FIG. 5 is a detailed sectional view of the door along lines V-V in FIG. 3;

FIG. 6 is an isometric view of a replaceable anchoring member of the rackmount case and in accordance with an illustrative embodiment of the present invention; and

FIG. 7 provides a detailed perspective view of a hinge connecting the rackmount case and door in accordance with an illustrative embodiment of the present invention.

### DETAILED DESCRIPTION OF THE ILLUSTRATIVE EMBODIMENTS

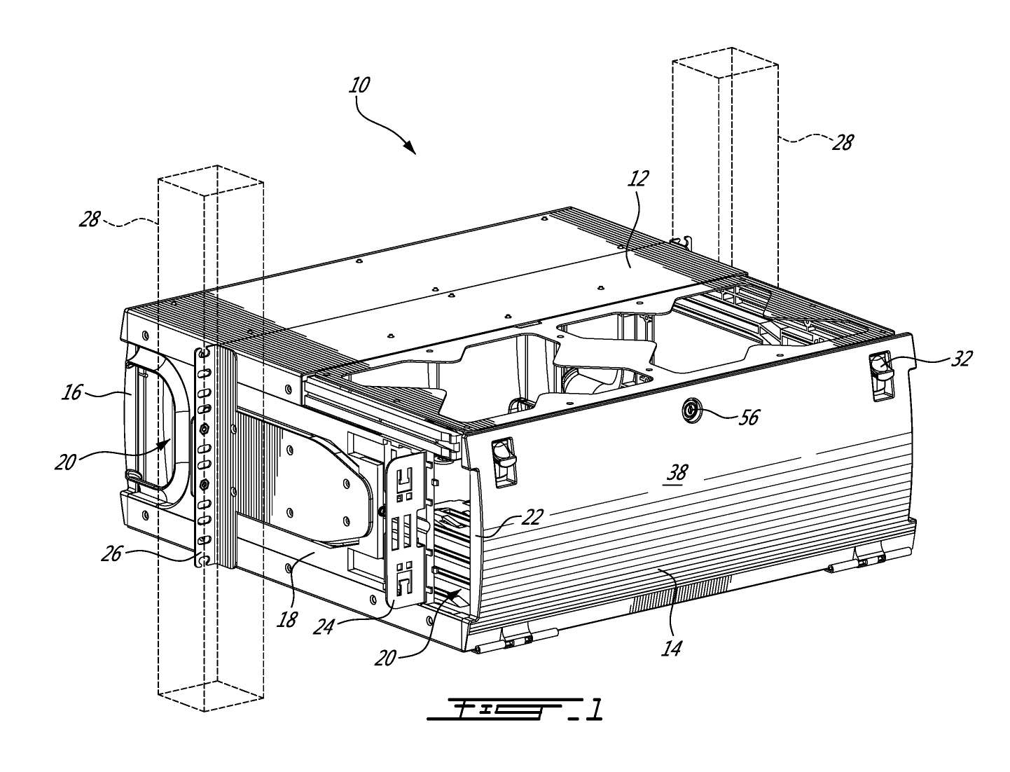

Referring now to FIG. 1, a rackmount case 10 in accordance with an illustrative embodiment of the invention will be described. The rackmount case 10 comprises a housing 12 and a door 14 for selectively opening and closing the rackmount case 10. The housing 12 is adapted to house optical equipment, such as a plurality of fibre optic cables. In particular, the rackmount case 10 includes means for housing and engaging a plurality of removable cassettes. Such cassettes may include further optical equipment. The rackmount case 10 also comprises a second door 16, which can comprise any or all of the features of the door 14 described herein.

The housing 12 of the rackmount case 10 comprises on each one of two side walls 18 two openings 20 for feeding through wires or cables even when the doors 14, 16 are closed. Each opening 20 is open in direction to the respective door. The door 14 comprises a cut 22 near the opening 20, the cut 22 further facilitating feeding through wires or cables. Each opening 20 can comprise a brush-type cover (not shown) preventing dust from entering the rackmount case 10.

The rackmount case 10 includes an anchor plate 24 adjacent the opening 20 facing the door 14. the anchor plate 24 illustratively extends perpendicular to the side wall 18. The anchor plate 24 comprises a plurality of openings or apertures, thereby providing the possibility to fix wires or cables to the plate 24 for example by means of a tie or a strap.

The side wall 18 of the rackmount case 10 further comprises a flange 26 for the fixation of the rackmount case 10 on two beams 28 of a rack, in particular a standard size rack for the accommodation of a plurality of rackmount cases.

The door 14 further comprises a lock 56 and two engagement hooks 32 for securing the door 14 in a closed position, as shown in FIG. 1.

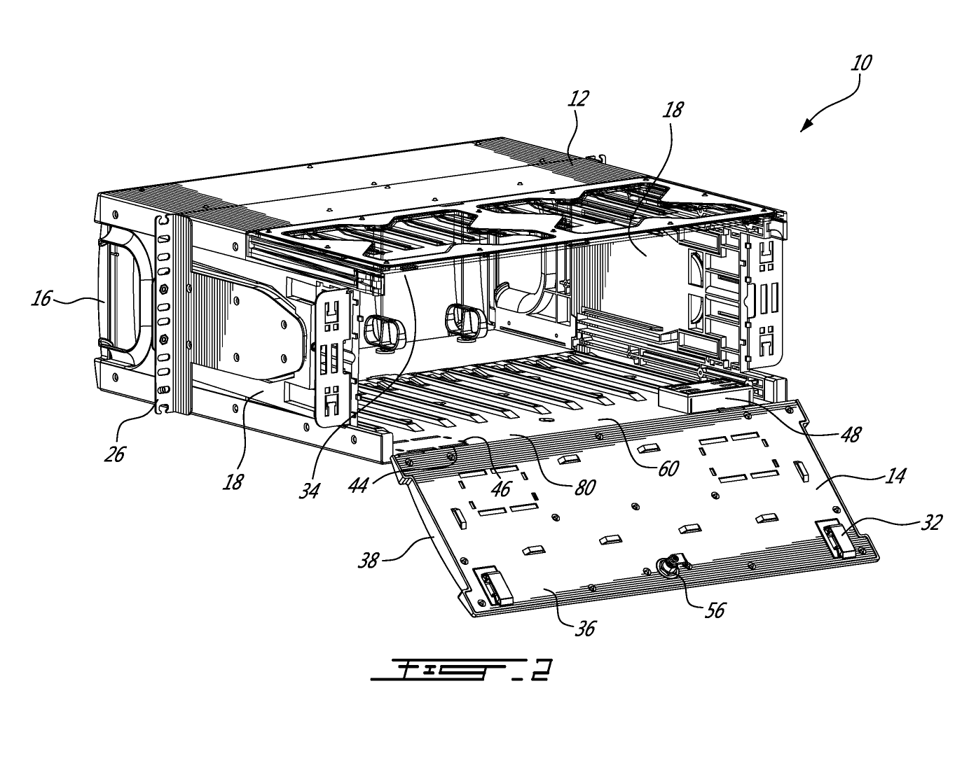

Referring now to FIG. 2, the rackmount case 10 of FIG. 1 is shown, wherein the door 14 is in an open position. As can be seen from FIG. 2, the housing 12 comprises engagement recesses 34 for the engagement of the hooks 32 with the housing 12 in order to secure the door 14 in its closed position.

The door 14 comprises a structural member 36, which is made from metal, for example a steel or aluminium sheet. The door 14 further comprises and aesthetic member 38 made from plastic, the aesthetic member 38 covering the structural member 36 from view when the door 14 is in the closed position, as shown in FIG. 1.

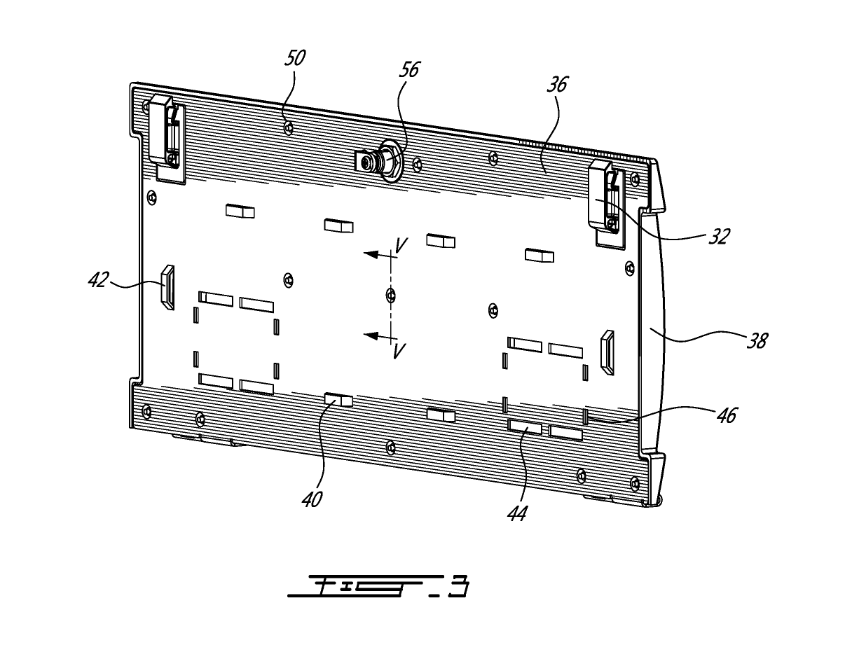

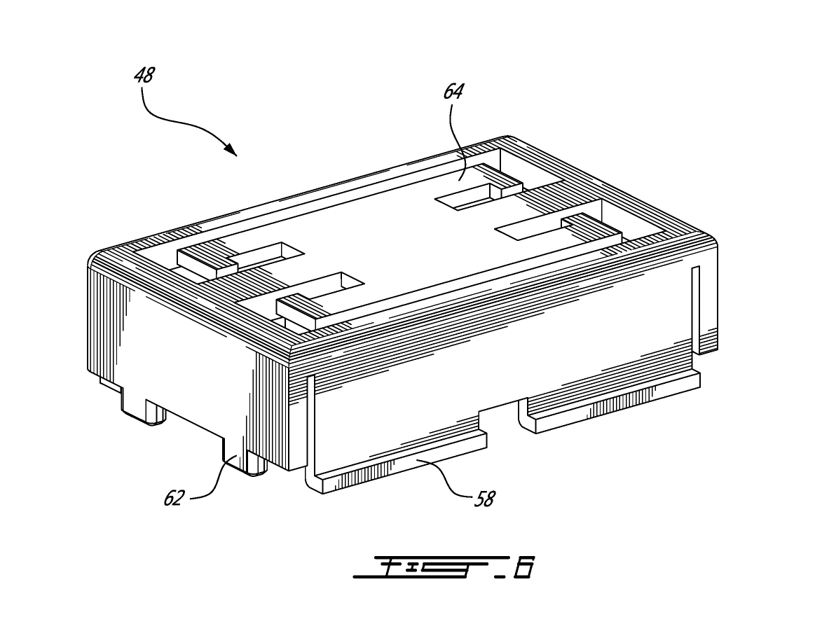

Referring now to FIG. 3, the door 14 is shown in more detail. The structural member 36 is a pressed metal sheet providing structural stability for the door 14. The structural member 36 comprises a plurality of anchors 40 and 42 for the attachment of wires or cables, for example by means of ties or straps. The anchors 40 and 42 are provided as metal loops extending from the metal sheet of the structural member 36. Referring to FIG. 6 in addition to FIG. 3, further, the structural member 36 comprises a plurality of openings 44, 46, four openings 44 and four openings 46 forming together a set of openings for receiving a replaceable anchoring member 48. The structural member 36 comprises two such sets of openings 44, 46. The structural member 36 further includes a plurality of recesses 50 for the fixation of the aesthetic member 38 to the structural member 36.

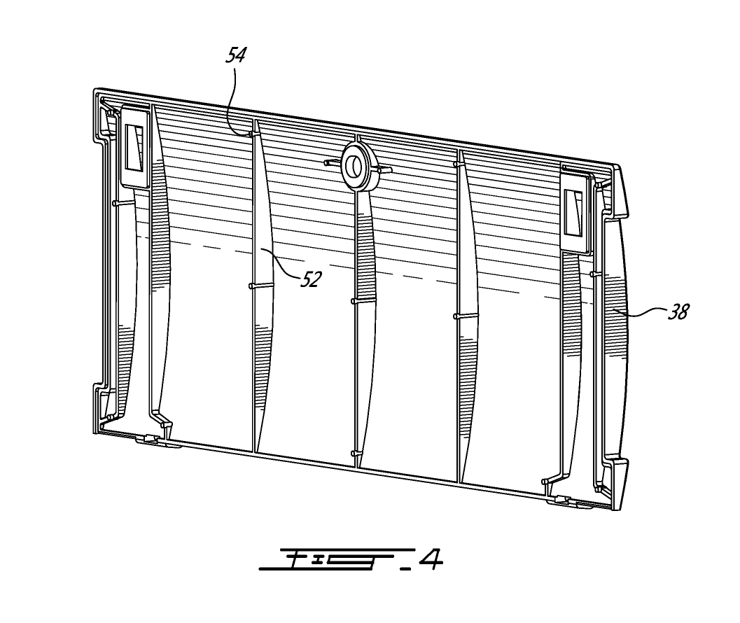

Referring now to FIG. 4, the aesthetic member 38 is made of plastic and is of a generally curved shape and comprises a plurality of ribs 52 for the reinforcement of the aesthetic member 38. The aesthetic member 38 further comprises a plurality of post like protrusions 54 the free ends of which are each received by a respective one of the recesses 50 of the structural member 36 (as shown in FIG. 3). A respective protrusion 54 and a respective recess 50 form together a fixation point in a manner described in more detail below. Although the protrusions 54 of the aesthetic member 38 are shown as parts of respective ribs 52, the protrusions 54 could also be located independently from the ribs 52 at the aesthetic member 38. As can further be seen from FIG. 4, the aesthetic member 38 also comprises apertures for engagement hooks 32 and lock 56, as for example shown in FIG. 3.

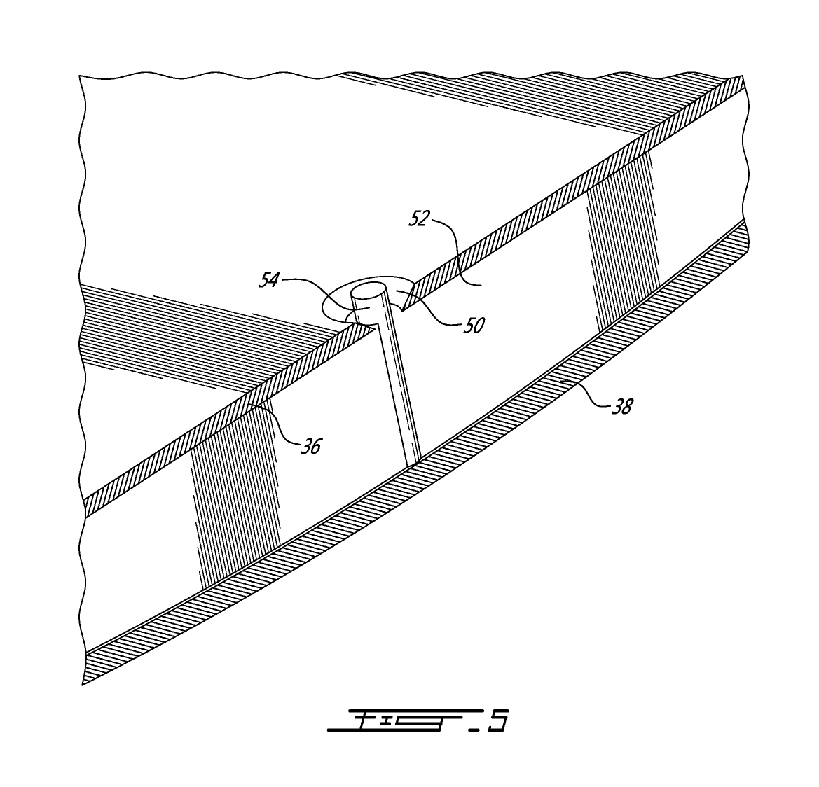

Referring now to FIG. 5, the fixation between the aesthetic member 38 and the structural member 36 is illustrated by means of a sectional, more detailed view, wherein the section plane extends along the line A-A indicated in FIG. 3. The protrusion 54 is, in the present embodiment, designed as a pin extending from the rib 52 through the recess 50. The recess 50 is, in the present embodiment, tapered in the direction of a root of the protrusion 54. In particular, the recess 50 is of a conical shape forming an annular shoulder. The structural member 36 abuts the rib 52.

Still referring to FIG. 5, the protrusion 54 is shown in an unconnected state. In other words, the structural member 36 and the aesthetic member 38 are shown at a point in time of the assembly of the rackmount case 10 before establishing a permanent, or one-way, connection between the aesthetic member 38 and the structural member 36. In order to establish this permanent one-way connection, the protrusion 54 can be formed or worked to acquire a shape, for example a head, engaging with the annular shoulder of the recess 50. In particular, the protrusion 54 can be deformed by heat or molten into a shape, which provides for a form-fit connection between the aesthetic member 38 and the structural member 36. For example, this can be achieved by pressing a hot plunger (not shown) onto an end surface of the protrusion 54. Thereby, a permanent fixation is established and the aesthetic member 38 can no longer be separated from the structural member 36 without the destruction of the connection. As it becomes apparent from FIG. 5, the described connection between the aesthetic member 38 and the structural member 36 does not require any separate mechanical fasteners, such as screws, thus providing for a cost-efficient process of assembly.

Referring back to FIG. 2, the rackmount case 10 also comprises a replaceable anchoring member 48, displayed in FIG. 6 in more detail. The replaceable anchoring member 48 is of a generally box-like shape and comprises a plurality of hooks 58 for the engagement with openings 44 of the structural member 36 or of a wall of the rackmount case 10, for example a bottom wall 60. The replaceable anchoring member 48 further comprises a plurality of stabilizing protrusions 62 for being received by openings 46 of the structural member 36 or the wall of the rackmount case 10. As can be seen in FIG. 2, the bottom wall 60 of the rackmount case 10 comprises two sets of openings 44, 46, each set of which being adapted to receive a replaceable anchoring member 48, as shown in FIG. 6. In FIG. 2 one such replaceable anchoring member 48 is engaged with one such set of openings 44, 46, the respective set of openings being covered by the replaceable anchoring member 48 in FIG. 2. A user of the rackmount case 10 can easily place the replaceable anchoring member 48 at any desirable one of the sets of openings 44, 46. Also, more than one replaceable anchoring member 48 could be used. For facilitating the desirable arrangement of wires or cables within the rackmount case 10, the replaceable anchoring member 48 comprises a plurality of protrusions 64, which can serve as anchors for fastening ties or strips to the anchoring member 48.

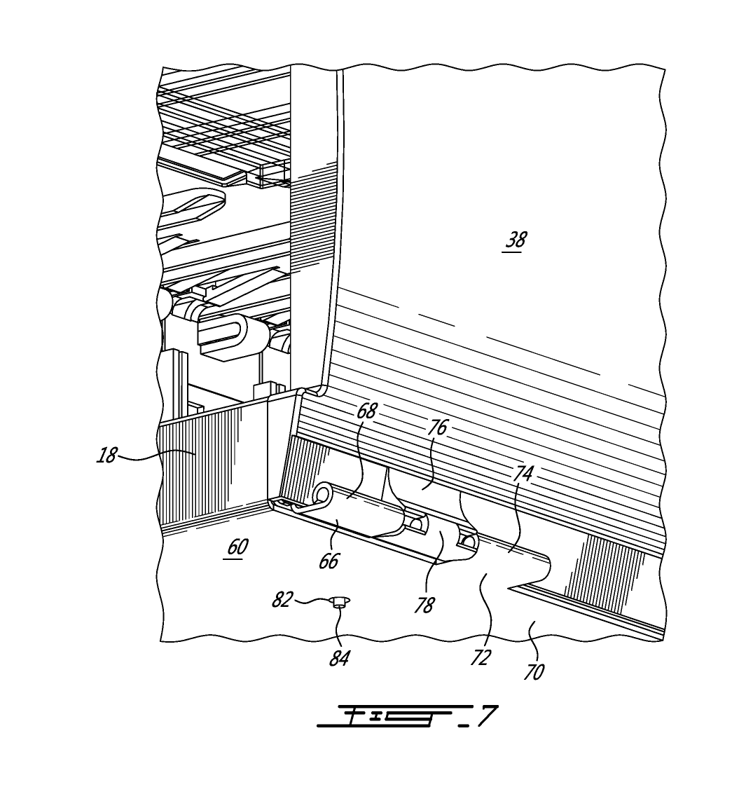

Referring now to FIG. 7, the door 14 is hingedly connected to the housing 12. In particular, the structural member 36, which in FIG. 7 is covered by the aesthetic member 38, comprises a flap 66 forming a knuckle 68. A metal base sheet 70 of the bottom wall 60 also comprises a flap 72 forming a knuckle 74. Both knuckles 68 and 74 are secured around a common hinge pin (not shown), in order to allow for the structural member 36 to revolve around the hinge pin relative to the bottom wall 60. Further, the aesthetic member 38 comprises a ridge portion 76 also forming a knuckle 78 to clasp around the hinge pin.

The bottom wall 60 is made up of the metal base sheet 70 and a functional member 80, which is made from plastic and can be seen in FIG. 2. The metal base sheet 70 and functional member 80 are fixed to each other in a manner similar to the connection between the aesthetic member 38 and the structural member 36 described above. In particular, the metal base sheet 70 comprises a recess 82, through which a protrusion 84 of the plastic functional member 80 extends to be molten into a shape engaging with an annular shoulder of the recess 82.

Although the present invention has been described hereinabove by way of specific embodiments thereof, it can be modified, without departing from the spirit and nature of the subject invention as defined in the appended claims.

We claim:

1. A rackmount case for the accommodation of optical equipment, the case comprising:
a metal housing comprising an open end; and
a door comprising dimensions substantially the same as said open end for selectively opening and closing said open end, said door comprising:
a structural member made from metal and hinged to said housing along a long edge of said open end; and
an aesthetic member made from plastic, said aesthetic member at least partially covering said structural member;
wherein said aesthetic member comprises a one-way attachment comprising a plurality of protrusions and said structural member comprises a plurality of recesses for receiving said protrusions, each of said protrusions comprising a head deformed by heat for engaging with a shoulder of a respective one of said recesses to hold said aesthetic member relative to said structural member.

2. The rackmount case of claim 1, wherein said aesthetic member obstructs viewing of said structural member when said door closes said open end.

3. The rackmount case of claim 1, wherein when said case is mounted in a rack, said structural member is hinged to said housing about a horizontal axis.

4. The rackmount case of claim 3, wherein said horizontal axis is adjacent a lower edge of said open end and such that aid door opens downwards.

5. The rackmount case of claim 1, wherein said aesthetic member is slightly curved away from said structural member, said structural member and said aesthetic member together define a hollow space therebetween and further wherein said aesthetic member comprises a plurality of spaced reinforcing ribs arranged widthwise with said hollow space.

6. A method of assembling rackmount assembly comprising:
providing an aesthetic member comprising an outer surface and an inner surface comprising a plurality of post like protrusions arranged in parallel to one another and generally at right angles to said inner surface;
securing said aesthetic member to a structural member by inserting a free end of each of said protrusions into a respective one of a plurality of recesses in said structural member, wherein following insertion, each of said free end is deformed such that it is retained within its respective recess; and
hingedly attaching an edge of said structural member to an opening of a rackmount case about a hinge axis and such that said structural member and said aesthetic member are rotatable about said hinge axis between an open position, wherein said rack mount case is accessible via said opening, and a closed position wherein said rackmount case is not accessible via said opening.

7. The method of claim 6, wherein said protrusion is deformed by melting said free end.
